(19) United States
(12) Patent Application Publication
(10) Pub. No.: US 2019/0212211 A1
(43) Pub. Date: Jul. 11, 2019

(54) HIGH TEMPERATURE FIBER OPTIC CABLE WITH STRAIN RELIEF AND PROTECTION FOR HARSH ENVIRONMENTS

(71) Applicant: Siemens Energy, Inc., Orlando, FL (US)

(72) Inventor: Christine P. Spiegelberg, Winter Park, FL (US)

(21) Appl. No.: 15/862,677

(22) Filed: Jan. 5, 2018

(51) Int. Cl. G01K 11/32; G01L 1/24; G01M 11/00

(52) U.S. Cl. CPC G01K 11/32; G01M 11/3172; G01L 1/242

(57) ABSTRACT

A fiber optic sensing apparatus is presented. An optical fiber sensor is enclosed within a housing. A sleeve is interposed between the housing and the optical fiber sensor such that the sleeve encloses the optical fiber sensor and is coaxial with the housing, the sleeve extending continuously along the entire length of the optical fiber sensor effective to constrain movement of the optical fiber sensor between the housing and the sleeve. A method to construct a flexible fiber cable having strain relief for the optical sensor as well as a method to accurately sense temperature conditions in a gas turbine are also provided.

### BACKGROUND

### 1. Field

The present disclosure relates generally to a fiber optic sensing apparatus for sensing applications at high temperatures, and more particularly, to a fiber optic sensing apparatus with improved fiber strain relief

### 2. Description of the Related Art

Fiber optic technology is currently used for sensing conditions in a high temperature environment, such as in a gas turbine engine. For fiber optic sensing applications at high temperatures, such as above 300° C., the glass fiber can no longer be mechanically protected by organic coatings like polyimide and strain relieving, hydrogen scavenging buffer gels, or flexible tubes made from organic compounds.

For such high temperatures, metal coated fibers are known to be used. These metal coatings are very thin, for example less than 1 micron, and while they provide some protection of the fiber surface, in harsh environments the fibers still require protection by a flexible metal sheathing or thin metal tube. The thin metal tube may include an inner diameter of a few millimetres. As the optical fiber is approximately 125 μm in diameter, its placement into the thin metal tube results in its ability to move freely in the relatively large metal tube. This movement may cause early fiber failure and measurement issues when the fiber cable is exposed to vibration.

Furthermore, many fiber sensing techniques show cross sensitivity between strain and temperature so that the sensing mechanism cannot distinguish between exposure to temperature or strain. The only known method of distinguishing between the two effects is by attaching or mounting the optical fiber differently. If, for example, the fiber is completely loose and able to expand and contract freely within the metal tube, all measured effects may be attributed to temperature alone. In contrast, if the fiber is attached to a component and strain is transferred to the fiber, an assumption may be made that the observed effect is a combination of temperature and strain effects. By using an optical fiber with strain relief and one strain transferring fiber next to each other, one can then extract both components from the measurement. This method for measuring operational gas turbine engine housing displacement/temperature by a distributed fiber optic sensing system is described in U.S. Pat. No. 9,359,910. However, while a protective metal tube, or sheathing, may provide some strain relief in the fiber, vibration inside a fiber optic cable where the optical fiber has the ability to move freely within the metal tube, leads to unpredictable strain in the fiber and makes the fiber cable unusable for pure temperature measurements.

Thus, due to the delicate nature of optical fibers, it is desirable to provide appropriate protection for such optical fibers in harsh, high temperature environments while additionally providing strain relief to the optical fiber so that the fiber cable may provide accurate distributed temperature sensing.

### SUMMARY

Briefly described, aspects of the present disclosure relate to a fiber optic sensing apparatus, a method to construct a flexible fiber cable having strain relief for the optical fiber sensor, and a method to accurately sense temperature conditions in a gas turbine engine.

A fiber optic sensing apparatus is presented. An optical fiber sensor is enclosed within a housing. A sleeve is interposed between the housing and the optical fiber sensor such that the sleeve encloses the optical fiber sensor and is coaxial with the housing, the sleeve extending continuously along the entire length of the optical fiber sensor effective to constrain movement of the optical fiber sensor between the housing and the sleeve.

A method to construct a flexible fiber cable having strain relief for the optical sensor is also provided. The method includes the steps of providing a housing to accommodate an optical fiber sensor, threading the optical fiber sensor (20) into a sleeve so that the sleeve extends continuously along the entire length of the optical fiber sensor, and pulling the threaded optical fiber sleeve assembly into the housing. This fiber optic cable including the sleeve is effective to constrain movement of the optical fiber sensor between the housing and the sleeve.

A method to accurately sense temperature conditions in a gas turbine engine is also presented. A fiber optic sensing apparatus as described above is coupled to a gas turbine engine casing. A temperature condition of the gas turbine engine along the length of the optical fiber sensor is measured using optical frequency domain reflectometry during engine operation.

### BRIEF DESCRIPTION OF THE DRAWINGS

FIG. 1 is a schematic view of a gas turbine engine that may benefit from a fiber optic sensing apparatus,

FIG. 2 is a cross sectional view illustrating an embodiment of a fiber optic sensing apparatus,

FIG. 3 is a perspective view of an embodiment of a fiber optic sensing apparatus, and

FIG. 4 is a known optical frequency domain reflectometry system that measures temperature influenced strain on an optical fiber.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

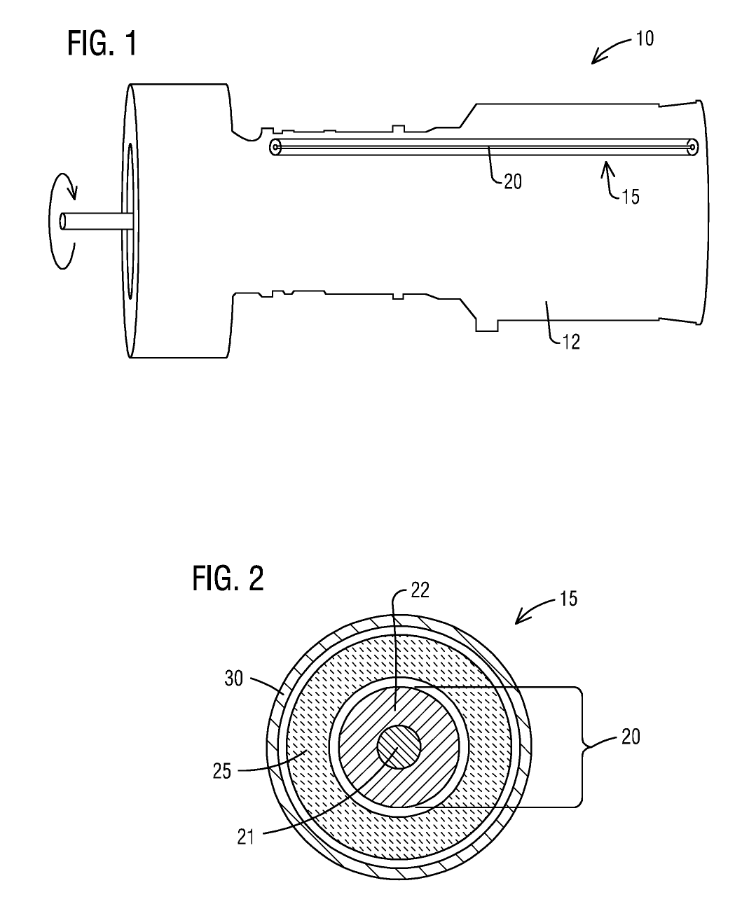

FIG. 1 is a schematic representation of a gas turbine engine 10, with a casing 12, to which is affixed an exemplary embodiment of a distributed fiber optic sensing apparatus 15. The fiber optic sensing apparatus 15 includes an elongated optical fiber sensor 20. In the illustrated embodiment, the fiber optic sensing apparatus 15 is mounted to the gas turbine engine 10 for distributed sensing of a condition of the gas turbine engine 10. The fiber optic sensing apparatus 15 may be mounted to the engine casing 12 by an adhesive such as an epoxy so that the fiber optic sensor 20 expands and contracts with casing displacement or temperature.

The fiber optic sensing apparatus 15 may be useful for all sensing applications where the environmental temperatures are above 300° C. For example, in a gas turbine engine 10 as illustrated in FIG. 1, the fiber optic sensing apparatus 15 may be coupled to the gas turbine outer casing 12 under the insulation, within the combustion section, in areas where exhaust flows, and other areas inside the casing 12.

The sensed condition of the gas turbine component may include temperature sensing, strain sensing, etc. It will be appreciated by one skilled in the art that the fiber optic sensing apparatus 15 may monitor other sensing conditions and/or other components.

FIG. 2 is a cross sectional view illustrating an embodiment of an assembly of a fiber optic sensing apparatus 15. The fiber optic sensing apparatus 15 includes an optical fiber sensor 20 enclosed in a housing 30. A space may exist between the housing 30 and the optical fiber sensor 20. Interposed between the housing and the optical fiber sensor 20, a sleeve 25 may be inserted to enclose the optical fiber sensor 20. The fiber optic sensor 20 may comprise optical fiber cladding 22 surrounding an optical fiber core 21. The sleeve 25 extends continuously along the entire length of the optical fiber sensor 20 constraining movement of the optical fiber sensor 20 between the housing 30 and the sleeve 25. The described embodiment of the fiber optic sensing apparatus 15 is configured to sense a condition of the gas turbine engine 10 along length of the optical fiber sensor 20.

In an embodiment, the housing 30 may be a flexible armored cable which is constructed from a wrapping of metal. In an alternate embodiment, the housing 30 may be a flexible metal tube.

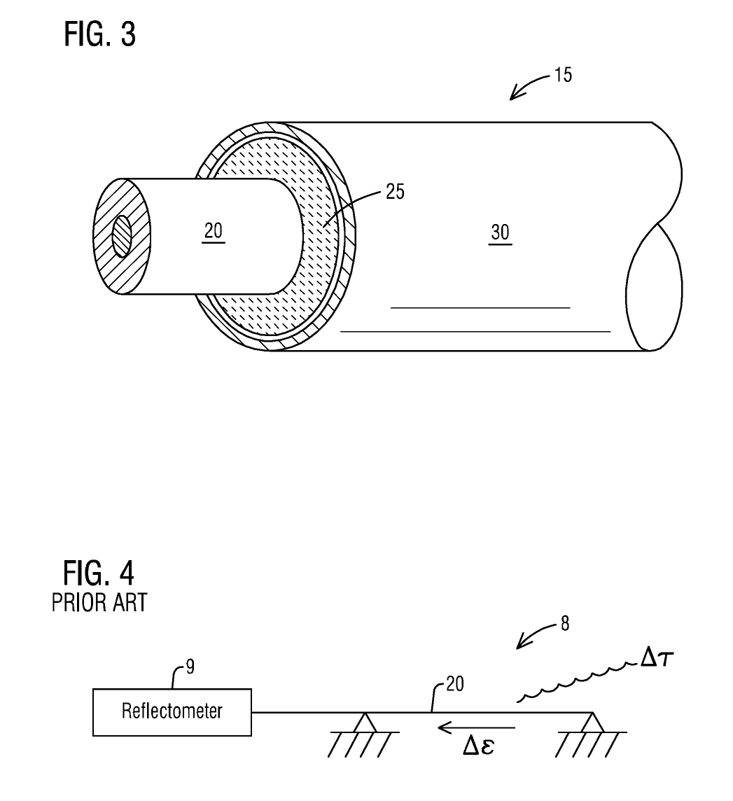

In an embodiment, the sleeve 25 fills the space between the housing 30 and the optical fiber sensor 20 as illustrated in FIG. 3 showing a perspective view of the fiber optic sensing apparatus 15. The sleeve 25 may be a cylindrical shaped structure interposed between the housing 30 and the fiber sensor 20 such that it abuts the inner diameter of a housing 30 and the outer diameter of a cylindrical optical fiber sensor 20. This arrangement of the sleeve interposed between the housing 30 and the fiber sensor 20 may constrain the movement, axial and/or radial, of the fiber sensor 20 with respect to the housing 30 and the sleeve 25.

In an embodiment, the sleeve 25 may comprise fiber glass. The fiber glass may be a woven material comprising a multifilament glass fiber yarn having a plurality of filaments enabling the sleeve to be flexible and pliable so that it may adapt to the inner surface of the housing 30. The fiber glass sleeve 25 may include a thickness in the range of 0.2-1.0 mm. For practical reasons, it may be advantageous to use a fiber glass sleeve 25 that contains an organic binder to make the optical fiber sleeve assembly 20, 25 stiff when assembling the fiber optic sensing cable. The binder may then be burned off after the fiber optic sensing apparatus 15 has been assembled and connectorized.

The presented fiber optic sensing apparatus 15 is effective to sense a condition within a harsh environment such as a gas turbine engine 10. Typical conditions to be sensed include strain and temperature measurements. A variety of sensing techniques may be employed based on, for example, Fiber Bragg gratings, or optical scattering processes in the fiber itself. Known optical frequency domain reflectometry (OFDR) systems 8, such as shown in FIG. 4, based on Rayleigh scattering in optical fiber 20 are capable of measuring with a reflectometer 9 the strain (ε), temperature (T), and to some degree even the shape of an optical fiber 20 or the component to which the fiber is attached. OFDR is a distributed measurement that results in measured information over the whole length of an optical fiber, which can be from several meters to several hundred meters long. Millimeter spatial resolution, high dynamic range, strain resolution of less than +/−1 microstrain, and temperature resolution of 0.1° C. can be achieved with today's technology.

The sleeve 25 may be effective to protect the optical fiber sensor 20 from the harsh environment of, for example, a combustor of a gas turbine engine 10 as well as vibration that may occur during operation of the gas turbine engine 10. In an embodiment, the harsh environment includes high temperatures such as in a range of 300° C. up to 800° C., a temperature range that is typically found inside a gas turbine engine 10.

Referring to FIGS. 1-4, a method to construct a flexible armored fiber cable 15 having strain relief for the optical fiber sensor 20 is presented. The optical fiber sensor 20 may be threaded into the high temperature sleeve 25 so that the sleeve 25 extends continuously along the entire length of the optical fiber sensor 20. This assembly 20, 25 may then be pulled through a housing 30 which may be a thin armored cable or a thin flexible metal tube. The sleeve 25 fits the optical fiber sensor 20 close enough so that the sleeve constrains movement of the optical fiber sensor 20.

The sleeve 25 may comprise an organic binder that stiffens the optical fiber sleeve assembly 20, 25 so that it may be easier to thread the assembly into the housing. The organic binder may be burned off after assembled in high temperatures such as in an oven or during operation of the gas turbine engine 10.

In another embodiment, a method to accurately sense temperature conditions in a gas turbine engine 10 is presented. The method utilizes the fiber optic sensing apparatus 15 described above to accurately measure temperature along the length of the optical fiber sensor 20. The fiber optic sensing apparatus 15 may be coupled to a gas turbine engine housing by affixing the fiber optic cable to the gas turbine engine component such as the casing 12. The affixing may be accomplished by epoxy, for example. Using optical frequency domain reflectometry as shown in FIG. 4, the temperature may be accurately measured during engine operation.

The fiber optic sensing apparatus described in this disclosure is far less sensitive to vibration. For example, the distributed Rayleigh temperature measurements were tested while the fiber optic cable was subjected to vibration and temperature simultaneously. In this example, the vibration frequencies were between 30 and 300 Hz. At vibration levels of 0.2-0.5 g, the data was very noisy and the data dropped out for vibration levels above 1 g. With the presented fiber optic sensing apparatus, the temperature data had low noise for vibration levels up to 4 g. Furthermore, the sleeve provides effective strain relief for the optical fiber sensor. Effective strain relief makes the optical fiber insensitive to strain that affects the fiber cable. The cable assembly may be used to measure temperature along the fiber without being affected by additional strain in the optical fiber. The cable construction provides a practical solution for distributed temperature measurements. While embodiments have been directed toward applications in a gas turbine, the presented sensing apparatus may be utilized in other applications where the optical fiber has to be used in harsh environments, such as in temperatures above 350° C.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A fiber optic sensing apparatus (15), comprising:
a housing (30) enclosing an optical fiber sensor (20);
a sleeve (25) interposed between the housing (30) and the optical fiber sensor (20) such that the sleeve (25) encloses the optical fiber sensor (20) and is coaxial with the housing (30), the sleeve (25) extending continuously along the entire length of the optical fiber sensor (20) effective to constrain movement of the optical fiber sensor (20) between the housing (30) and the sleeve (25),
wherein the fiber optic sensing apparatus (15) senses a condition of a component along length of the optical fiber sensor (20).

2. The fiber optic sensing apparatus (15) of claim 1, wherein the sleeve (25) fills a space between the housing (30) and the optical fiber sensor (20) so that the sleeve abuts an inner diameter of the housing and an outer diameter of the optical fiber sensor.

3. The fiber optic sensing apparatus (15) of claim 1, wherein the housing (30) is an armored cable or a metal tube.

4. The fiber optic sensing apparatus (15) of claim 1, wherein the sleeve (25) comprises fiber glass.

5. The fiber optic sensing apparatus of claim 3, wherein the sleeve (25) further comprises an organic binder effective to provide stiffness for assembling the sleeve (25) interposed between the housing (30) and the optical fiber sensor (20).

6. The fiber optic sensing apparatus (15) of claim 1, wherein the optical fiber sensor (20) is arranged to sense a condition of a gas turbine engine (10) and is selected from the group consisting of a strain sensor and a temperature sensor.

7. The fiber optic sensing apparatus (15) of claim 1, wherein the sleeve (25) is effective to protect the optical fiber sensor (20) from a combustion environment in a gas turbine engine (10).

8. The fiber optic sensing apparatus (15) of claim 1, wherein the sleeve (25) protects the optical fiber sensor (20) from an environment in which the temperature is in a range between 300° C.-800° C.

9. A method to construct a flexible fiber cable having strain relief for the optical fiber sensor (20), comprising the steps of:
providing a housing (30) to accommodate an optical fiber sensor (20);
threading the optical fiber sensor (20) into a sleeve (25) so that the sleeve (25) extends continuously along the entire length of the optical fiber sensor (20); and
pulling the threaded optical fiber sleeve assembly (20, 25) into the housing (30),
wherein the sleeve (25) is effective to constrain movement of the optical fiber sensor (20) between the housing (30) and the sleeve (25).

10. The method as claimed in claim 7, wherein the sleeve (25) further comprises an organic binder effective to provide stiffness for assembling the fiber cable 15, the assembling comprising the threading and the pulling.

11. The method as claimed in claim 7, further comprising burning the organic binder off of the sleeve (25) in an oven having a temperature above 300° C.

12. A method to accurately sense temperature conditions in a gas turbine engine (10), comprising:
coupling a fiber optic sensing apparatus (15) to a gas turbine engine casing (12) wherein the fiber optic sensing apparatus (15) comprises,
a housing (30) enclosing an optical fiber sensor (20);
a sleeve (25) interposed between the housing and the optical fiber sensor such that the sleeve (25) encloses the optical fiber sensor and is coaxial with the housing (30), the sleeve (25) extending continuously along the entire length of the optical fiber sensor (20) effective to constrain movement of the optical fiber sensor (20) between the housing (30) and the sleeve (25);
measuring a temperature condition of the gas turbine engine (10) along the length of the optical fiber sensor (20) by optical frequency domain reflectometry during engine operation.

13. The method as claimed in claim 12, wherein the sleeve (25) further comprises an organic binder effective to provide stiffness for an assembly of the fiber sensing apparatus (15).

14. The method as claimed in claim 13, further comprising burning the organic binder off during gas turbine operation.
